(19) United States
(12) Patent Application Publication
(10) Pub. No.: US 2014/0065482 A1
(43) Pub. Date: Mar. 6, 2014

(54) METHOD FOR FORMING BATTERY ACTIVE SUPER-IRON NANOPARTICLES AND STORAGE BATTERY

(71) Applicant: The George Washington University, (US)

(72) Inventor: Stuart LICHT, Leesburg, VA (US)

(73) Assignee: The George Washington University, Washington, DC (US)

(21) Appl. No.: 13/726,791

(22) Filed: Dec. 26, 2012

Related U.S. Application Data
(63) Continuation of application No. PCT/US2011/042740, filed on Jul. 1, 2011.
(60) Provisional application No. 61/360,523, filed on Jul. 1, 2010.

(51) Int. Cl. H01M 4/52; B02C 19/00

(52) U.S. Cl. CPC H01M 4/52; B02C 19/0056
USPC 429/221; 241/30; 241/23; 241/27

(57) ABSTRACT

A method for forming nanometer-sized super-iron salt particles and a storage battery having the nanometer-sized super oxidized iron salts is provided. The method includes providing super-iron salts, and grinding the super-iron salts to nanometer-sized super-iron salt particles in a water-free environment.

### BACKGROUND

Today, higher capacity electrochemical energy storage materials are desirable to increase the energy storage capacity of batteries. Increased energy storage would be useful in devices ranging from portable consumer electronics to lightweight medical and military devices.

Some iron materials and salts exists with iron in the +2 valence state (ferrous salts), +3 valence state (ferric salt), or as iron metal. Super-iron materials are a unique class of iron salts. The super-iron materials exist in the super-oxidized +6 valence state.

A decrease of particle size from micrometer to nanometer provides an opportunity to facilitate charge transfer of battery materials, and an improvement in power, voltage and depth of discharge of batteries. A decrease in particle size increases the surface area to volume ratio. However, while this promotes electrochemical charge transfer, it exposes the particles to a greater risk of decomposition through enhanced chemical reactivity.

Super-iron materials are readily reduced to the ferric state (+3 valence state) upon exposure to heat, contact with water or a combination thereof. Prior methods to form super-iron battery materials involved one, or more, water containing steps.

Therefore, a need exists for a method of decreasing super-iron particle size to the nanometer scale while overcoming the tendency of the super-iron materials to be reduced and retaining the battery advantage of the Fe (VI) valence state.

### SUMMARY

Disclosed herein is a method of forming nanometer-sized super-iron salt particles. The method comprises grinding super-iron salts to nanometer-sized super-iron salt particles in a water-free environment.

A storage battery is also disclosed herein. The storage battery comprises a first half cell and a second half cell in electrochemical contact with each other through an electrically neutral ionic conductor, wherein the first half cell comprises an anode and the second half cell comprises a cathode and the cathode comprises nanometer-sized super-iron salt particles.

### BRIEF DESCRIPTION OF THE DRAWINGS

FIG. 1 is a diagram illustrating a storage battery.

FIG. 2 is a chart illustrating an example of a discharge of super-iron batteries.

FIG. 3 is a scanning electron microscope (SEM) image of micrometer-sized super-iron particles compared to nanometer-sized super-iron salt particles.

### DETAILED DESCRIPTION

Super-iron salt particles can comprise at least one of an alkali salt, an alkali earth salt, a trivalent metal salt, a transition metal salt or a mixture or alloy of super-iron salts. Exemplary alkali salts include, for example, Li₂FeO₄, Na₂FeO₄, K₂FeO₄, Ru₂FeO₄ or Cs₂FeO₄. Exemplary alkali earth salts include, for example, Ba₂FeO₄, Sr₂FeO₄. Exemplary trivalent metal salts include, for example, Al₄(FeO₄)₃. Exemplary transition metal salts include, for example, Ag₂FeO₄. Further, as mentioned above, the super-materials may be formed of any mixture or alloy of the above-identified super-iron salts.

A method of forming nanometer-sized super-iron salt particles comprises grinding super-iron salts to nanometer-sized super-iron salt particles in a water-free environment. A water-free environment may comprise an inert gas such as argon or nitrogen. Grinding is performed for predetermined intervals having cooling periods between each predetermined interval. Each predetermined interval and each cooling period can be of approximately the same length of time. For example, the predetermined interval may be approximately 5 minutes while the cooling period between each predetermined interval may also be approximately 5 minutes long. The cooling period may be chosen so that sufficient time is allowed for the milled material to radiate the majority of the heat generated during each milling period. In some embodiments, the cooling period may be of a less time than each interval or vice versa. In other embodiments, the cooling period may be of a greater time than each interval or vice versa.

In various embodiments, grinding devices, such as, but not limited to, jaw crushers, cutting mills, knife mills, blenders, disc mill and mortar grinders may be employed, in a water-free environment. In one embodiment, the grinding is performed using a planetary ball mill The grinding operation may be performed at a rotation rate greater 100 rotations per minute (rpm) and less than or equal to 300 rpm. The water-free environment can be achieved by using an inert dry gas (e.g., argon or nitrogen).

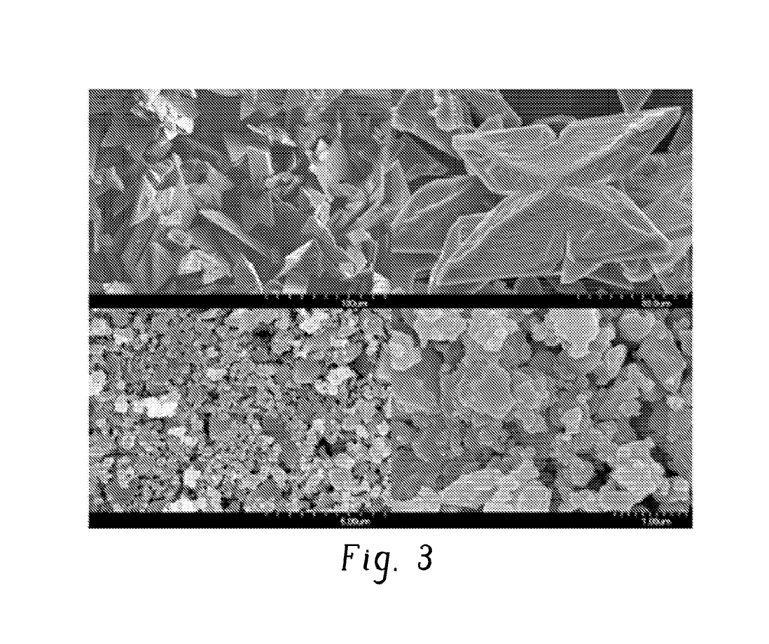

FIG. 3 is a scanning electron microscopy (SEM) 300 illustrating micrometer-sized super-iron particles compared to nanometer-sized super-iron salt particles that can be obtained by the method described herein. As shown in the upper portion 305 of SEM 300, the K₂FeO₄ material which has not been subjected to the method described herein includes micrometer sized particles (particles having at least one single linear dimension which is 1 micrometer or larger). In contrast, particles which have been treated by the method described herein comprise nanometer-sized particles (particles which have no single linear dimension which is greater than 100 nanometers). In some embodiments the particles resulting from the method described herein comprise greater than or equal to 90% nanometer-sized particles, or, more specifically, greater than or equal to 95% nanometer-sized particles, based on the total number of particles.

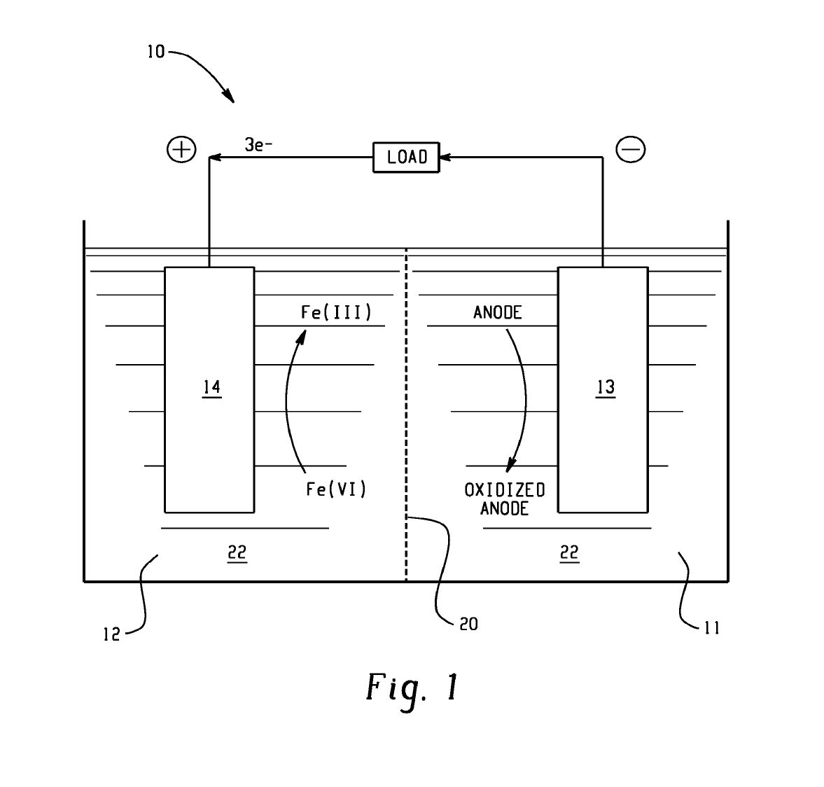

With reference now to FIG. 1, in FIG. 1 a storage battery 10 is shown. The storage battery 10 comprises a first half cell 11 and a second half cell 12 in electrochemical contact with each other through an electrically neutral ionic conductor 22, wherein the first half cell 11 comprises an anode 13 and the second half cell 12 comprises a cathode 14. The cathode comprises nanometer-sized super-iron salt particles (as depicted in FIG. 3, for example). The conductor 22 comprises a medium that may support current density during battery discharge. The conductor 22 may be an aqueous solution comprising a high concentration of hydroxide (for example, greater than or equal to 8 molar) such as KOH or any other suitable ionic conductor material. Such conductors are known in the art.

The anode 13 may comprise a metal capable of being oxidized. For example, the anode 13 may comprise zinc, lithium or lithium ion; any common battery anode material such as cadmium, lead and iron; a metal hydride, a high capacity metals such as aluminum, magnesium, calcium; or another metals such as copper, cobalt, nickel, chromium, gallium, titanium, indium, manganese, silver, cadmium, barium, tungsten, molybdenum, sodium, potassium, rubidium, and cesium.

As further shown in FIG. 1, the storage battery 10 may comprise an ion selective membrane 20 as a separator, for minimizing the non-electrochemical interaction between the anode 13 and the cathode 14.

Conventional ball milling was attempted as a technique to decrease the super-iron salt particle size. However, the presence of water is known to induce oxidative decomposition of super-irons, and the rate of this decomposition increases with heat, such as the heat generated during ball milling. Additionally, the decrease in particle size increases the rate of this decomposition. Accordingly conventional ball milling appeared induce thermal decomposition of the super-iron salt.

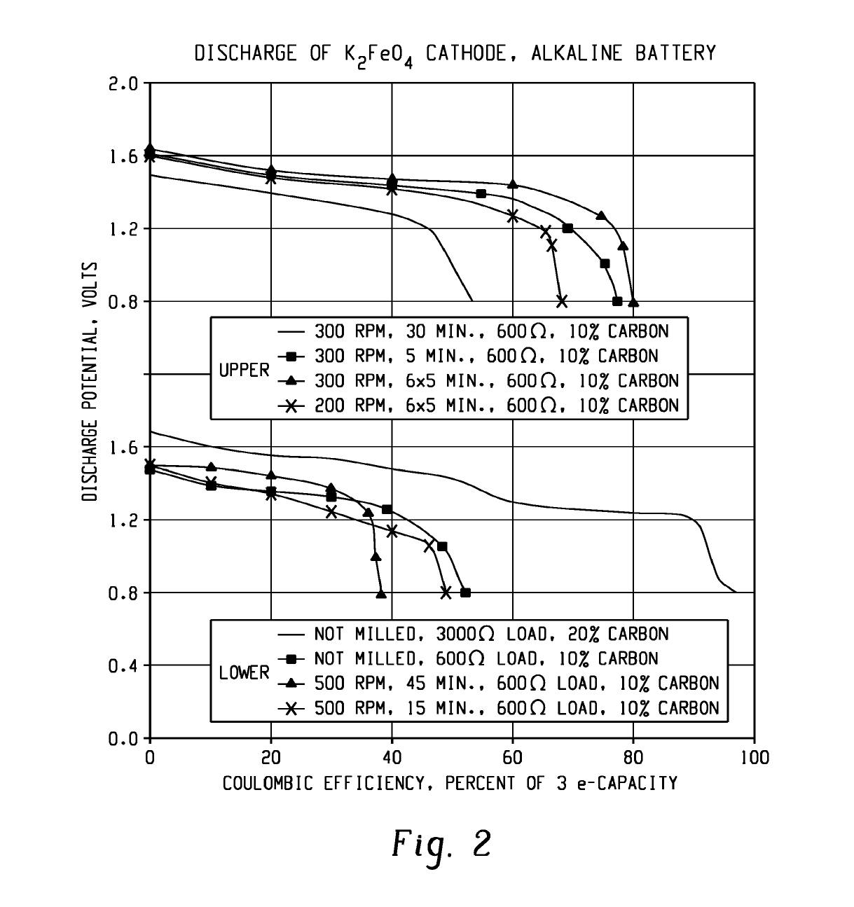

As shown in the lower portion of FIG. 2, conventional ball milling of K₂FeO₄ heats the particles and converts some to the ferric state. Chemically synthesized, re-crystallized K₂FeO₄ was milled in a Restch PM 100 planetary ball in a steel vessel with steel grinding balls at approximately 500 revolutions per minute (rpm) ball milling for approximately 45 minutes. The resulting nanometer-size particles and 10 weight percent carbon (based on the total amount of K₂FeO₄ and carbon) were used to form a cathode. The cathode had a decreased coulombic efficiency (approximately 37%) compared to the coulombic efficiency of a comparable cathode made using non-milled K₂FeO₄ (53% coulombic efficiency). However the discharge voltage increased and the coulombic efficiency increased to approximately 47% when the milling time was shortened to approximately 15 minutes. As seen an the upper portion of FIG. 2, at a lower mill speed of approximately 300 rpm for approximately 30 minutes, the coulombic efficiency further improved to approximately 53%. At this rotation speed, and a shorter mill time of approximately 5 minutes, the discharge voltage increased, and the coulombic efficiency substantially increased to approximately 73%. The highest coulombic efficiency of approximately 80% under the low carbon, high rate discharge conditions, was observed at this rotation speed with a six fold repetition of approximately 5 minutes mill times, each repetition including approximately 5 minutes of cooling time. As a result of experimentation it was determined that lower rotation speed (below 300 rpm) and lower carbon black additives decrease the coulombic efficiencies. For example, under the same 6×5 minute 300 rpm ball conditions, and under a 600 ohm discharge load, the milled K₂FeO₄ yielded respectively 12%, 55%, 77% and 80% coulombic efficiencies when mixed respectively with 3%, 5%, 7% and 10% carbon black by weight. When combined with 10% carbon black but milled for 6×5 minutes at 100, 200 or 300 rpm, the coulombic discharge efficiency was 56% (not shown), 67% (as depicted in the upper portion of FIG. 2) or 80%, for example.

Now referring back to FIG. 3, a comparison is made between the micrometer particle size of conventionally chemically synthesized K₂FeO₄ particles 305 and nanometer-sized K₂FeO₄ salt particles 310 that have been produced by ball mill technique in approximately six 5 minute intervals, with approximately 5 minute cool time between mills, in dry argon or dry nitrogen conditions, for example, at approximately 300 rpm. As shown, the majority of the conventional particles at 305 ranges in size from approximately 100 to 500 micrometers, whereas the nanometer-sized K₂FeO₄ particles which are not only 2 to 3 orders of magnitude smaller than the conventional particles but also as seen in FIG. 2, still retain the high 3e− storage capacity, of active Fe(VI) super-iron cathode materials.

Now referring back to FIG. 2, when the K₂FeO₄ is mixed with a high carbon content (e.g., 20%), and when discharged at a low rate of approximately 3000 ohms, the discharge potential is high, and the cathode 14 as shown in FIG. 1, for example, releases the majority of the three electron theoretical capacity of approximately 406 mA/g K₂FeO₄, available when this Fe (VI) is reduced to Fe(III). However, as seen in FIG. 2, the coulombic efficiency and sustainable discharge voltage falls significantly to approximately 53% depth of discharge to approximately 0.8 volts (V) when the discharge rate is increased, by decreasing the load resistor five fold to approximately 600 ohms and when the carbon added to the K₂FeO₄ to support conductive is decreased from 20% to approximately 10% by weight.

By providing a method of forming nanometer-sized super-iron salt particles using a less aggressive dry and cool ball milling technique in a water-free environment, the method provides the advantages of a unique multiple electron opportunity to store additional battery charge. A wide-variety of super-iron batteries may be formed, for example Li-ion super-iron batteries and alkaline super-iron batteries. The charge storage is accomplished by using alkali super-iron salts, such as Li₂FeO₄, Na₂FeO₄, K₂FeO₄, Ru₂FeO₄, Cs₂FeO₄, and mixtures of alloys of those salts. Charge storage has also been accomplished via alkali earth super-iron salts, such as BaFeO₄ and SrFeO₄, and also via a transition metal super-iron salt, Ag₂FeO₄. The highly oxidized state of iron also provides an alternative to chlorination to disinfect and to treat waste water.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for forming nanometer-sized super-iron salt particles, the method comprising:
grinding the super-iron salts to nanometer-sized super-iron salt particles in a water-free environment.

2. The method of claim 1, wherein the grinding is for an interval of 5 to 15 minutes.

3. The method of claim 1 or 2, further comprising cooling after grinding.

4. The method of claim 3, wherein the grinding is at predetermined intervals having cooling periods between each predetermined interval.

5. The method of any of claims 1 to 4, wherein the super-iron salt comprises an alkali salt.

6. The method of any of claims 1 to 4, wherein the super-iron salt comprises an alkali earth salt.

7. The method of any of claims 1 to 4, wherein the super-iron salt comprises a trivalent metal salt.

8. The method of any of claims 1 to 4, wherein the super-iron salt comprises a transition metal salt.

9. The method of any of claims 1 to 4, wherein the super-iron salt comprises a mixture or alloy of super-iron salts.

10. The method of any of claims 1 to 9, wherein the grinding is performed by a planetary ball mill.

11. The method of any of claims 1 to 9, wherein the grinding is performed by at least one of jaw crushers, cutting mills, knife mills, blenders, disc mill or mortar grinders.

12. The method of claim 10, wherein the grinding is performed at a low rotation rate to prevent thermal build-up.

13. The method of claim 12, wherein the grinding is performed at a rotation rate of 100 to 300 revolutions per minute.

14. The method of claim 4, wherein each predetermined interval and each cooling period is of approximately a same length of time.

15. The method of claim 4, wherein the cooling period is of a lesser time than each interval.

16. The method of claim 4, wherein the cooling period is of a greater time than each interval.

17. A storage battery comprising:
a first half cell; and
a second half cell in electrochemical contact with the first half cell through an electrically neutral ionic conductor,
wherein the first half cell comprises an anode and the second half cell comprises a cathode and the cathode comprises nanometer-sized super-iron salt particles.

18. The storage battery of claim 17, wherein the nanometer-sized super-iron salt particles are formed by the method of any of claims 1 to 16.
